(19) United States
(12) Patent Application Publication
(10) Pub. No.: US 2025/0037949 A1
(43) Pub. Date: Jan. 30, 2025

(54) VACUUM INTERRUPTER, VACUUM CIRCUIT BREAKER, AND VACUUM CONTACTOR

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventors: Yoshinori MORI, Kawasaki (JP); Akira KANO, Kawasaki (JP); Takeshi YOSHIDA, Fuchu (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 18/444,838

(22) Filed: Feb. 19, 2024

(30) Foreign Application Priority Data
Jul. 24, 2023 (JP) 2023-120046

(51) Int. Cl. H01H 33/664; H01H 1/02; H01H 1/0233; H01H 33/662

(52) U.S. Cl. CPC H01H 33/664; H01H 1/0203; H01H 1/0233; H01H 33/66207

(57) ABSTRACT

According to one embodiment, a vacuum interrupter includes a vacuum insulation container, a fixed side contact provided in the vacuum insulation container, and a movable side contact provided in the vacuum insulation container and configured to contact and separate from the fixed side contact. A first contact surface of the movable side contact configured to contact the fixed side contact is planar. A second contact surface of the fixed contact configured to contact the movable side contact is spherical protruding toward the movable side contact.

### CROSS-REFERENCE TO RELATED APPLICATIONS

This application is based upon and claims the benefit of priority from Japanese Patent Application No. 2023-120046, filed on Jul. 24, 2023; the entire contents of which are incorporated herein by reference.

### FIELD

Embodiments described herein relate generally to a vacuum interrupter, a vacuum circuit breaker, and a vacuum contactor.

### BACKGROUND

Vacuum interrupters used, for example, in vacuum circuit breakers and vacuum contactors configured to open and close frequently are desired to achieve both reduction and stability in contact resistance. Conventional vacuum interrupters use a pair of disc-shaped contacts, and current opening and closing is performed by contacting and opening of the contacts. As a vacuum interrupter with a small rated capacity, a vacuum interrupter that uses contacts with spherical contact surfaces is proposed to obtain stable current-carrying performance with a small pressing force.

### BRIEF DESCRIPTION OF THE DRAWINGS

FIG. 1 is a cross-sectional view illustrating an exemplary structure of a vacuum interrupter according to an embodiment;

FIG. 2 is a diagram illustrating an example of relation between the contact area and the contact resistance;

FIG. 3 is a diagram illustrating an example of relation between the radius of curvature of a contact and the contact area;

FIG. 4 is a diagram for illustrating occurrence of slippage in a comparative example;

FIG. 5 is a diagram for illustrating occurrence of slippage in another comparative example;

FIG. 6 is a diagram for illustrating balance of forces in the embodiment; and

FIG. 7 is a view illustrating an exemplary structure of a vacuum circuit breaker using the vacuum interrupter.

### DETAILED DESCRIPTION

According to an embodiment, a vacuum interrupter includes a vacuum insulation container, a fixed side contact provided in the vacuum insulation container, and a movable side contact provided in the vacuum insulation container and configured to contact and separate from the fixed side contact. A first contact surface of the movable side contact configured to contact the fixed side contact is planar. A second contact surface of the fixed side contact configured to contact the movable side contact is spherical protruding toward the movable side contact. Preferred embodiments of a vacuum interrupter according to the present disclosure will be explained below in detail with reference to the accompanying drawings.

A vacuum interrupter that uses a contact with a spherical contact surface on both an electrode on a fixed side (hereinafter referred to as a “fixed side electrode”) and an electrode on a movable side (hereinafter referred to as a “current-carrying side electrode”) (hereinafter referred to as a “comparative example”) is proposed. In the vacuum interrupter of the comparative example, it has been found that, when the central axes of the fixed and movable side electrodes are eccentric, slippage (shearing) on the contact surfaces results in formation of coagulation and a hole having a maximum height of about 50 μm on the surfaces, in addition to a high contact surface pressure between the contacts.

Furthermore, in case of the failure of contacting at the position where the coagulation is aligned with the hole, the contact area significantly decreases and the contact resistance increases. If, due to increased contact resistance, the current path becomes deflected and the contact part overheats, leading to fusion, the interrupting performance may be degraded.

To stabilize the contact state, a technique is proposed to make the contact surface planar. However, in a structure in which planes make contact with each other, when the central axes of the fixed and movable side electrodes are eccentric, a contact on the fixed side (hereinafter referred to as a “fixed side contact”) and a contact on the movable side (hereinafter referred to as a “movable side contact”) change from surface contact in which the entire contact surfaces are in contact with each other to point contact that is peripherad-biased. In such a case, the contact area significantly decreases and the contact resistance increases.

As another technique to stabilize the contact state, a technique is proposed to make the center of one of the contacts a recessed-cone shape. However, making the center of the contact a recessed-cone shape can contribute to increased manufacturing costs and unevenness in quality.

Making the contacts in surface contact with each other as in the aforementioned two techniques leads to an increase in the peel force when fusion occurs. To suppress the peel force, the contacts are desirably in point contact with each other as in the vacuum interrupter of the comparative example.

Thus, vacuum interrupters configured to open and close frequently face problems of achieving both reduction and stability in contact resistance. Increasing the contact area when contacts make contact with each other is effective at reducing contact resistance. On the contrary, preventing wear and damage on the contact surfaces caused by the contact between the contacts is effective at maintaining stability of the contact resistance (contact state).

As such, a contact surface of a contact used for a fixed side electrode (fixed side contact) of a vacuum interrupter being spherical (spherical shape) is combined with a contact surface of a contact used for a movable side electrode (movable side contact) being planar (planar shape) in the present embodiment. This combination enables a vacuum interrupter with a low contact resistance and stable contact resistance characteristics over a long period of time.

In other words, the vacuum interrupter of the present embodiment has a larger contact area than, for example, the structure using spherical contacts as in the comparative example, and thus has a lower contact resistance. Even when the movable side electrode is tilted to make contact, the slippage (horizontal shearing force) is reduced during contacting, so that wear on the surfaces of the contacts and surface damage are less likely to occur. This allows the contact state to be stabilized to maintain excellent contact resistance characteristics over the long term.

In the following explanation, the direction in which the movable side electrode moves is the vertical direction, and the direction in which slippage occurs is the horizontal direction. When the direction in which the movable side electrode moves is another direction DA, the direction in which slippage occurs is a direction DB that is orthogonal to the direction DA.

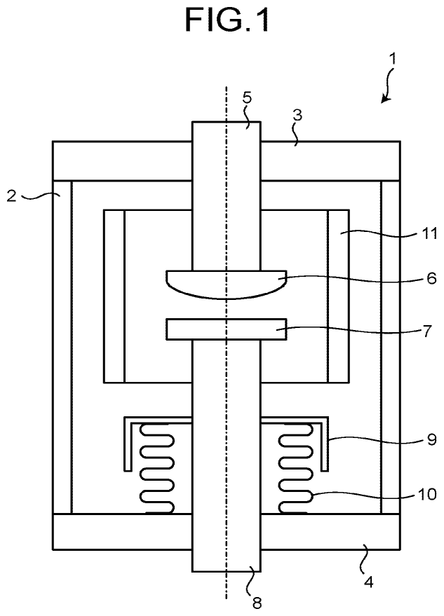

FIG. 1 is a cross-sectional view illustrating an exemplary structure of a vacuum interrupter 1 according to the present embodiment. As illustrated in FIG. 1, the vacuum interrupter 1 includes a vacuum insulation container 2, a fixed side sealing fixture 3, a movable side sealing fixture 4, a fixed side electrode 5, a fixed side contact 6, a movable side contact 7, a movable side electrode 8, a bellows cover 9, and bellows 10.

The vacuum insulation container 2 is formed in a cylindrical shape, for example. Openings at both ends of the vacuum insulation container 2 are sealed with the fixed side sealing fixture 3 and the movable side sealing fixture 4. The fixed side sealing fixture 3 is fixed with the fixed side electrode 5 penetrating. The fixed side contact 6 is attached to the end of the fixed side electrode 5 in the vacuum insulation container 2. A contact surface (second contact surface) of the fixed side contact 6 configured to contact the movable side contact 7 is formed in a spherical shape protruding toward the movable side contact 7.

The movable side electrode 8 is an electrode provided so as to penetrate the movable side sealing fixture 4. The movable side contact 7 that is freely contacting and separating is attached to the end of the movable side electrode 8 in an opposed manner to the fixed side contact 6. Contacting and separating means contact and separation. In other words, the movable side contact 7 contacts the fixed side contact 6 or separates from the fixed side contact 6 in accordance with the movement of the movable side electrode 8. A contact surface (first contact surface) of the movable side contact 7 configured to contact the fixed side contact 6 is planarly formed.

The flatness of the contact surface of the movable side contact 7 should be determined so that wear and surface damage do not occur, for example. For example, the contact surface of the movable side contact 7 may be planarly formed with a flatness of 0.1 mm or less.

The bellows cover 9 is provided in the middle of the movable side electrode 8. The freely-extendable bellows 10 is sealed between the bellows cover 9 and the movable side sealing fixture 4. An arc shield 11 that surrounds the fixed side contact 6 and the movable side contact 7 is fixed to the inner surface of the vacuum insulation container 2.

The electrodes (fixed side electrode 5, movable side electrode 8) and the contacts (fixed side contact 6, movable side contact 7) may be made of any material, and are made of a composite material containing tungsten carbide (WC), cobalt (Co), and silver (Ag), for example.

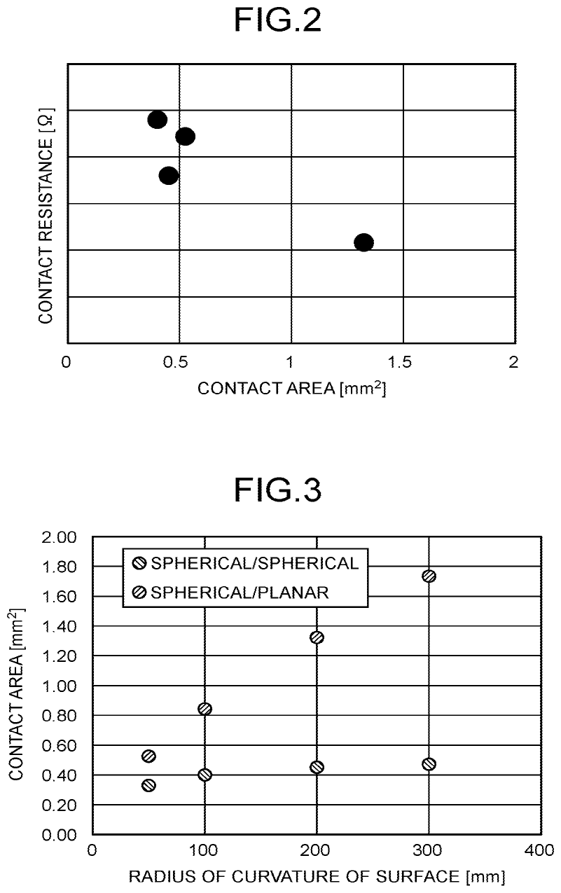

To reduce contact resistance, which is one of the problems to be solved by the present embodiment, the contact area when the contacts make contact with each other has been found to be an indicator. FIG. 2 is a diagram illustrating an example of relation between the contact area and the contact resistance. FIG. 2 illustrates an example of relation between the contact area and the contact resistance when spherical surfaces having different radii of curvature make contact with each other. As illustrated in FIG. 2, the contact resistance decreases with an increase in contact area. The contact area can be calculated based on, for example, Hertzian contact theory.

In the present embodiment, a combination of the spherical fixed side contact 6 and the plane movable side contact 7 is used instead of a combination of spherical contacts as in the comparative example. This enables the contact area to be increased more than the comparative example with the same pressing force, thereby reducing the contact resistance.

FIG. 3 is a diagram illustrating an example of relation between the radius of curvature of the contact surface (surface) of a contact and the contact area. The radius of curvature represents the radius of curvature of the contact that is spherical. In the case of the combination of a planar contact and a spherical contact as in the present embodiment, the contact area increases with an increase in radius of curvature of the spherical contact. On the contrary, in the case of the combination of two spherical contacts as in the comparative example, the contact area hardly increases even with an increase in radius of curvature.

Because one of the contacts is spherical in the present embodiment, the form of contact is point contact as in the comparative example. Consequently, the peel force when fusion occurs can be reduced compared with the technique in which the contacts are in surface contact with each other.

The contact surface of the movable side electrode 8 may be formed to have a counterbore at the center thereof. This structure can, for example, increase the contact area more.

For stability of contact resistance, which is the other problem to be solved by the present embodiment, preventing wear on the contact surfaces and surface damage is effective. This is because researches to date by the inventor reveal that vacuum interrupters with increased contact resistance damage contact surfaces (minute convexoconcave formation) due to wear. Additionally, the researches to date reveal that the condition for damage to occur at the surface is that slippage occurs when the contacts make contact with each other.

In a structure in which the contacts of the same spherical shape are used on both the fixed and movable sides as in the comparative example, when the central axis of the movable side electrode is eccentric, horizontal components of contact load and reaction force are not balanced at the contact point, and slippage (shearing) on the contact surfaces is prone to occur.

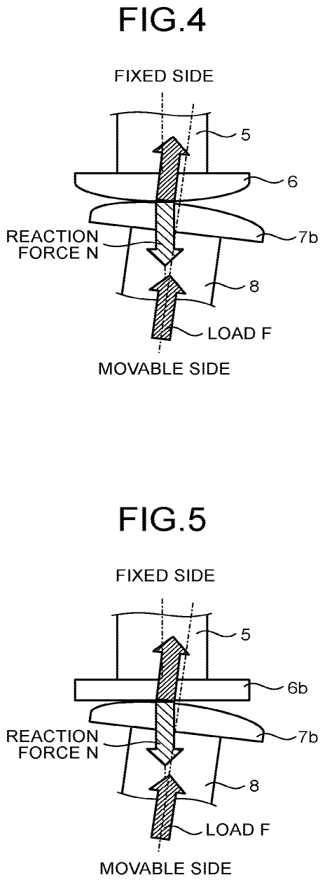

FIG. 4 is a diagram for illustrating occurrence of slippage in the comparative example. As illustrated in FIG. 4, a spherical movable side contact 7b is used in a comparative example. In such a structure, a load F (contact load) applied to the movable side electrode 8 includes a horizontal component in accordance with the eccentricity of the central axis. On the contrary, the reaction force N from the fixed side electrode 5 does not include a horizontal component or includes a horizontal component smaller than the load F. As a result, the horizontal components of the load F and the reaction force N are not balanced, and slippage (shearing) on the contact surfaces is prone to occur.

FIG. 5 is a diagram for illustrating occurrence of slippage in another comparative example. In the comparative example of FIG. 5, a fixed side contact 6b is planar and the movable side contact 7b is spherical. In such a structure, the load F includes a horizontal component in accordance with the eccentricity of the central axis. On the contrary, the reaction force N from the fixed side electrode 5 does not include a horizontal component or includes a horizontal component smaller than the load F. As a result, the horizontal components of the load F and the reaction force N are not balanced, and slippage (shearing) on the contact surfaces is prone to occur.

In contrast, in the present embodiment, the fixed side contact 6 is spherical, and even if the central axis of the movable side electrode 8 is eccentric, the horizontal components of contact load and reaction force are easily balanced at the contact point. As a result, slippage (shearing) on the contact surfaces is less likely to occur.

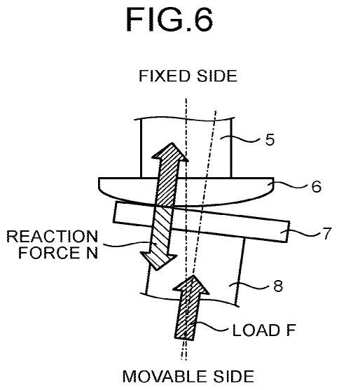

FIG. 6 is a diagram for illustrating balance of forces in the present embodiment. As illustrated in FIG. 6, not only the load F but also the reaction force N from the fixed side electrode 5 include a horizontal component in accordance with the eccentricity of the central axis in the present embodiment. As a result, the horizontal components of the load F and the reaction force N are easy to be balanced, and slippage (shearing) on the contact surfaces is less likely to occur.

The radius of curvature of the fixed side contact 6 should be determined so that the value of the contact area is appropriate. For example, the radius of curvature of the fixed side contact 6 can be equal to or greater than the length of the movable side electrode 8 in the movable direction. This allows suppression of slippage (shearing) on the contact surfaces even when the central axis of the movable side electrode 8 is eccentric, for example.

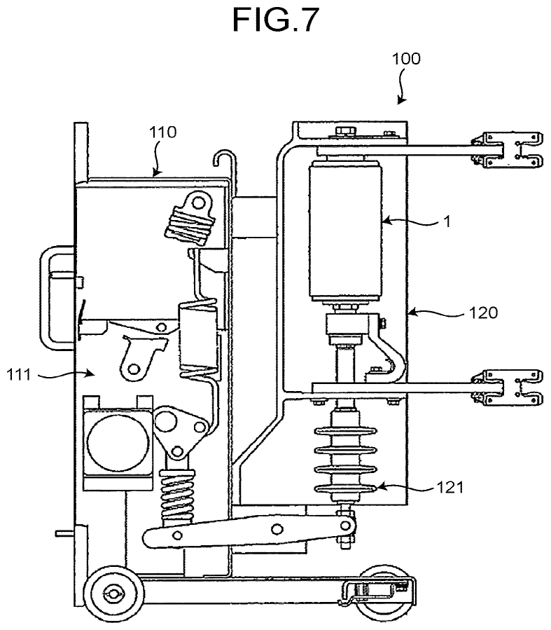

The vacuum interrupter 1 of the present embodiment may be used in any equipment, and can be used as a component of a vacuum circuit breaker and a vacuum contactor, for example. FIG. 7 is a view illustrating an exemplary structure of a vacuum circuit breaker 100 using the vacuum interrupter 1. Because a vacuum contactor has a structure similar to that of a vacuum circuit breaker, FIG. 7 can also be interpreted as an exemplary structure of a vacuum contactor 100.

As illustrated in FIG. 7, the vacuum circuit breaker 100 includes an operating mechanism part 110 and a shutoff part 120. The operating mechanism part 110 includes an operating mechanism 111. The shutoff part 120 includes the vacuum interrupter 1 and a rod 121. The operating mechanism 111 moves the movable side electrode 8 of the vacuum interrupter 1 through the rod 121.

Although FIG. 7 illustrates one vacuum interrupter 1, the vacuum circuit breaker 100 may be provided with a plurality of (e.g., three) the vacuum interrupters 1. The structure of FIG. 7 is an example, and the vacuum interrupter 1 may be used in vacuum circuit breakers (vacuum contactors) having any structures other than that of FIG. 7.

Thus, the vacuum interrupter of the embodiment has a spherical contact surface on the fixed side contact and a planar contact surface on the movable side contact. This allows both reduction and stability in contact resistance to be achieved.

Exemplary structures of the embodiments will be described below.

Example 1. According to an embodiment, a vacuum interrupter includes a vacuum insulation container, a fixed side contact provided in the vacuum insulation container, and a movable side contact provided in the vacuum insulation container and configured to contact and separate from the fixed side contact. A first contact surface of the movable side contact configured to contact the fixed side contact is planar. A second contact surface of the fixed side contact configured to contact the movable side contact is spherical protruding toward the movable side contact.

Example 2. In the vacuum interrupter according to example 1, the fixed side contact and the movable side contact are made of a composite material containing tungsten carbide (WC), cobalt (Co), and silver (Ag).

Example 3. In the vacuum interrupter according to example 1, the first contact surface is planar with a flatness of 0.1 mm or less.

Example 4. In the vacuum interrupter according to example 1, the first contact surface has a counterbore at a center.

Example 5. In the vacuum interrupter according to example 1, the second contact surface has a radius of curvature equal to or greater than a length of a movable side electrode in a movable direction, the movable side electrode to which the movable side contact is attached.

Example 6. According to an embodiment, a vacuum circuit breaker includes the vacuum interrupter according to example 1.

Example 7. According to an embodiment, a vacuum contactor includes the vacuum interrupter according to example 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A vacuum interrupter comprising:
a vacuum insulation container;
a fixed side contact provided in the vacuum insulation container; and
a movable side contact provided in the vacuum insulation container and configured to contact and separate from the fixed side contact, wherein
a first contact surface of the movable side contact configured to contact the fixed side contact is planar, and
a second contact surface of the fixed side contact configured to contact the movable side contact is spherical protruding toward the movable side contact.

2. The vacuum interrupter according to claim 1, wherein the fixed side contact and the movable side contact are made of a composite material containing tungsten carbide (WC), cobalt (Co), and silver (Ag).

3. The vacuum interrupter according to claim 1, wherein the first contact surface is planar with a flatness of 0.1 mm or less.

4. The vacuum interrupter according to claim 1, wherein the first contact surface has a counterbore at a center.

5. The vacuum interrupter according to claim 1, wherein the second contact surface has a radius of curvature equal to or greater than a length of a movable side electrode in a movable direction, the movable side electrode to which the movable side contact is attached.

6. A vacuum circuit breaker, comprising:
the vacuum interrupter according to claim 1.

7. A vacuum contactor, comprising:
the vacuum interrupter according to claim 1.
